(19) United States
(12) Patent Application Publication
(10) Pub. No.: US 2003/0003827 A1
(43) Pub. Date: Jan. 2, 2003

(54) Structural component and a method for producing same

(76) Inventor: Gunther Mikats, Hirm (AT)

Correspondence Address: YOUNG & THOMPSON, 745 SOUTH 23RD STREET 2ND FLOOR, ARLINGTON, VA, 22202

(21) Appl. No.: 10/181,812

(22) PCT Filed: Dec. 21, 2000
(86) PCT No.: PCT/AT00/00349

(30) Foreign Application Priority Data
Jan. 25, 2000 (AT) A 102/2000

(51) Int. Cl. B32B 3/00; B32B 5/02; B32B 9/00

(52) U.S. Cl. 442/59

(57) ABSTRACT

A plate-shaped structural component (1) includes a core layer (2) that is made of foamed synthetic material and outer layers (3) that are made of synthetic material and are arranged on both sides of the core layer 92). Two-dimensional stiffening layers (4) are arranged between the core layer (2) and the outer layers (3) that are made of synthetic material. The stiffening layers (4) are perforated and connected to the core layer (2) and the outer layers (3) in such a way that no adhesives are used.

The invention relates to a panel-shaped building component consisting of a core layer of foamed plastic and outside plastic layers attached on either side to the core layer, between the core layer and the outside plastic layers there being flat stiffening layers. The invention relates furthermore to a process for producing this panel-shaped building component.

### PRIOR ART

Building components of this type are already known, as the stiffening layers among others metal sheets, preferably of aluminum, being used. These stiffening layers are cemented over the entire surface to the core layer or the bordering outside layers. This cementing can be done relatively easily in the continuous production of the panel-shaped component, for example by bilateral application of an adhesive layer to the metal sheets. Under conditions of use under which the panel-shaped component is exposed to high shearing forces and/or thermal stresses, a high composite strength is necessary, and it cannot be easily achieved with cementing.

### DESCRIPTION OF THE INVENTION

The object of the invention is to make available a panel-shaped building component which compared to known building components, is characterized by increased composite strength and at the same time can be produced in a simple and efficient manner.

As claimed in the invention a panel-shaped building component of the initially mentioned type is proposed which is characterized in that the stiffening layers are perforated and are joined free of adhesive both to the core layer and also to the outside layers.

The connection between the core layer and outside layers takes place advantageously by their being welded to one another especially by the formation of welding grooves in the area of the perforations of the stiffening layers. The prerequisite for this is that the materials used in the core layer and the outside layers are thermoplastics which can be welded to one another. Advantageously the thermoplastic materials can be polyolefins, for example polyethylene (PE) or polypropylene (PP) and/or polyamides (PA) and/or polystyrene (PS) and/or styrene polymerizates, for example acrylonitrile-butadiene-styrene polymers (ABS), acrylic ester-styrene-acrylonitrile polymer (ASA) or styrene-acrylonitrile-copolymer (SAN) as well as thermoplastic polyesters, for example polyethylene terephthalate (PETP) or polybutyleneterephthalate (PBTP).

Advantageously, metal sheets which consist preferably of steel, aluminum or a metal alloy are used as perforated stiffening layers between the core and outside layers in the panel-shaped building component as claimed in the invention.

One advantageous configuration of the perforation in the stiffening layers consists in that they are made hole-like or slot-like, preferred embodiments for these perforated stiffening layers being those in the form of gratings or screens. Furthermore, it is also possible to use as the perforated stiffening layers between the core and outside layers fabrics or fiber composites, for example fiber-reinforced panels, and they can be of an inorganic or organic nature.

The subject matter of the invention is furthermore a process for producing a panel-shaped component of the initially mentioned type which is characterized in that bilaterally perforated stiffening layers are placed on the plastic melt of the core layer which is prepared and foamed in an extruder, consequently the plastic melts of the outside layers prepared in other extruder units are applied to the perforated stiffening layers, and that a connection between the respective layers is formed by subsequent pressing.

Materials for the core and outside layers are preferably thermoplastics which can be welded to one another. Suitable thermoplastic materials are especially polyolefins, for example polyethylene (PE) or polypropylene (PP) and/or polyamides (PA) and/or polystyrene (PS) and/or styrene polymerizates, for example acrylonitrile-butadiene-styrene polymers (ABS), acrylic ester-styrene-acrylonitrile polymer (ASA) or styrene-acrylonitrile-copolymer (SAN), as well as thermoplastic polyesters, for example polyethylene terephthalate (PETP) or polybutyleneterephthalate (PBTP).

Furthermore, preferably metal sheets, specifically of steel, aluminum or metal alloys, are used as perforated stiffening layers.

Especially hole-like or slot-like stiffening layers, preferably in the form of a grating or screen, can be used as perforated stiffening layers.

Furthermore, it is possible to use as the perforated stiffening layers those in the form of fabrics or fiber composites, for example of fiber-reinforced panels, and the materials used therein can be of an inorganic or organic nature.

### ONE METHOD OF IMPLEMENTING THE INVENTION WITH EXPLANATION OF THE FIGURES

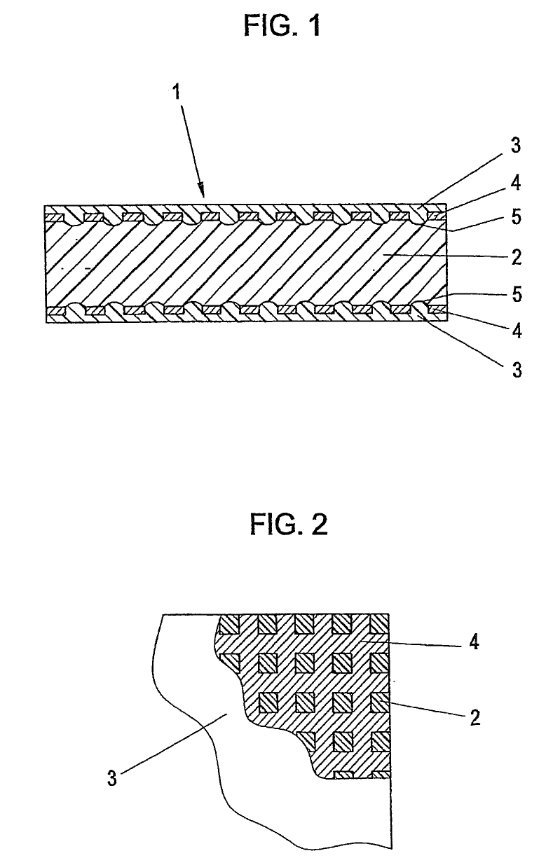

The invention is detailed using the drawings on one embodiment. FIG. 1 shows a section through a building component and FIG. 2 shows a building component with the outside layer partially removed.

FIG. 1 shows the panel-shaped building component 1 as claimed in the invention, consisting of the core layer 2 of foamed plastic adjoined on both sides by the outside layers 3, also of plastic. Between the core layer 2 and the outside layers 3 there are perforated stiffening layers 4. The connection between the outside layers 3 and the core layer 2 is made by welding of the plastic in the core layer 2 to the plastic of the outside layers 3 in the area of the welding grooves 5.

FIG. 2 shows the panel-shaped building component 1 as claimed in the invention with the outside layer 3 torn open in one strip. This shows that the perforated stiffening layer 4 is connected both to the core layer 2 and also to the cover layer 3. The connection between the core layer 2 and the outside layers 3 is accomplished by the welding grooves 5 which lie in the area of the perforations of the stiffening layers 4, which perforations are square in FIG. 2.

The production of the building component as claimed in the invention is detailed using one embodiment:

The panel-shaped building component 1 as claimed in the invention can be produced in a known system consisting of extruders and a downstream double belt press as the calender. In the extruder unit the plastic melt for the core layer which can additionally contain propellants for foaming is prepared. This plastic melt can be produced for example from polypropylene in granulate form. The perforated stiffening layers 4 with a thickness of preferably 0.1-1.0 mm are applied on both sides to this plastic melt, by which the stiffness of the building component is clearly increased. The stiffening layers 4 can be for example perforated aluminum foils roughly 0.5 mm thick. Then the plastic melts for the outside layers 3 are applied to these perforated aluminum foils which are used as stiffening layers 4. These plastic melts can like the core layer consist of polypropylene and are obtained in separate extruder units from the corresponding plastic base materials.

Based on the perforations made in the stiffening layers 4, for example in the aforementioned aluminum foil, both the melt of the outside layers 3 and also the melt of the core layer 2 can penetrate through the perforation so that a type of “melt composite” is formed. The composite adhesion which is advantageous for the panel-shaped building component 1 is produced by pressing this “melt composite” in a downstream double belt press such that the layers are welded to one another in the area of the welding grooves 5. Furthermore, the panel-shaped building component 1 is calibrated accordingly by the contact pressure applied in the double belt press. Then it is cooled and can be worked for example by sawing.

### Commercial Applicability

The panel-shaped building component 1 as claimed in the invention is extremely dimensionally stable and can be easily worked, for example by cutting, nailing or sawing. Furthermore the panel-shaped building component as claimed in the invention is weather-resistant so that it can be used not only inside, but also outside. One especially preferred application is outside for sheathing of buildings.

1. Panel-shaped building component (1) consisting of a core layer (2) of foamed plastic and outside plastic layers (3) attached on either side to the core layer (2), between the core layer (2) and the outside plastic layers (3) there being flat stiffening layers (4), characterized in that the stiffening layers (4) are perforated and are joined free of cement both to the core layer (2) and also to the outside layers (3).

2. Panel-shaped building component as claimed in claim 1, wherein the perforation in the stiffening layers (4) is made hole-like or slot-like.

3. Panel-shaped building component as claimed in claim 1 or 2, wherein the stiffening layers (4) are welded both to the core layer (2) and also to the outside layers (3).

4. Panel-shaped building component as claimed in one of claims 1 to 3, wherein the core layer (2) and the outside layers (3) consist of thermoplastic materials which can be welded to one another.

5. Panel-shaped building component as claimed in one of claims 1 to 4, wherein the core layer (2) with the outside layers (3) is welded in the area of the perforation of the stiffening layers (4).

6. Panel-shaped building component as claimed in claim 4 or 5, wherein the thermoplastic materials are polyolefins, for example polyethylene (PE) or polypropylene (PP) and/or polyamides (PA) and/or polystyrene (PS) and/or styrene polymerizates, for example acrylonitrile-butadiene-styrene polymers (ABS), acrylic ester-styrene-acrylonitrile polymer (ASA) or styrene-acrylonitrile-copolymer (SAN) as well as thermoplastic polyesters, for example polyethylene terephthalate (PETP) or polybutyleneterephthalate (PBTP).

7. Panel-shaped building component as claimed in one of claims 1 to 6, wherein the perforated stiffening layers (4) consist of metal sheet.

8. Panel-shaped building component as claimed in claim 7, wherein the metal sheet consists of steel, aluminum or a metal alloy.

9. Panel-shaped building component as claimed in one of claims 1 to 6, wherein the perforated stiffening layers (4) are made in the form of a grating or screen.

10. Panel-shaped building component as claimed in one of claims 1 to 6, wherein the perforated stiffening layers (4) are present in the form of fabrics or fiber composites, for example of fiber-reinforced panels.

11. Panel-shaped building component as claimed in claim 10, wherein the materials used in the fabrics, mats or fiber composites are of an inorganic or organic nature.

12. Process for producing a panel-shaped building component as claimed in one of claims 1 to 11, wherein bilaterally perforated stiffening layers are placed on the plastic melt of the core layer which is prepared and foamed in an extruder, consequently the plastic melts of the outside layers prepared in other extruder units are applied to the perforated stiffening layers, and wherein a connection between the respective layers is formed by subsequent pressing.

13. Process as claimed in claim 12, wherein hole-like or slot-like stiffening layers are used as the perforated stiffening layers.

14. Process as claimed in claim 12 or 13, wherein thermoplastic materials which can be welded to one another are used to produce the core layer and the outside layer.

15. Process as claimed in claim 14, wherein polyolefins, for example polyethylene (PE) or polypropylene (PP) and/or polyamides (PA) and/or polystyrene (PS) and/or styrene polymerizates, for example acrylonitrile-butadiene-styrene polymers (ABS), acrylic ester-styrene-acrylonitrile polymer (ASA) or styrene-acrylonitrile-copolymer (SAN) as well as thermoplastic polyesters, for example polyethylene terephthalate (PETP) or polybutyleneterephthalate (PBTP) are used as the thermoplastic materials.

16. Process as claimed in one of claims 12 to 15, wherein metal sheets are used as the perforated stiffening layers.

17. Process as claimed in claim 16, wherein metal sheets of steel, aluminum or a metal alloy are used as the metal sheets.

18. Process as claimed in one of claims 12 to 15, wherein gratings or screens are used as the perforated stiffening layers.

19. Process as claimed in one of claims 12 to 15, wherein perforated stiffening layers in the form of fabrics or fiber composites, for example of fiber-reinforced panels, are used as the perforated stiffening layers.

20. Process as claimed in claim 19, wherein the materials used in the fabrics, mats or fiber composites are of an inorganic or organic nature.
